(19) United States
(12) Patent Application Publication
(10) Pub. No.: US 2003/0101046 A1
(43) Pub. Date: May 29, 2003

(54) Word, expression, and sentence translation management tool

(76) Inventor: Mark Krasnov, Houston, TX (US)

Correspondence Address: ROSENTHAL & OSHA L.L.P., 1221 MCKINNEY AVENUE, SUITE 2800, HOUSTON, TX, 77010, US

(21) Appl. No.: 10/141,404

(22) Filed: May 8, 2002

Related U.S. Application Data
(60) Provisional application No. 60/333,927, filed on Nov. 28, 2001.

(51) Int. Cl. G06F 17/28

(52) U.S. Cl. 704/7

(57) ABSTRACT

A translation management method includes comparing text to terms in at least one glossary, indicating matches between the terms and the text, and selectively inserting a translation of matching terms into the text. A translation management tool includes at least one glossary containing terms and a translation of the terms and software executable on a computer for comparing text to terms in the at least one glossary, indicating matches between the terms and the text, and selectively inserting a translation of matching terms into the text

### CROSS-REFERENCE TO RELATED APPLICATIONS

This application claims priority from provisional patent application No. 60/333,927 filed Nov. 28, 2001.

### BACKGROUND OF INVENTION

In the art of computerized foreign language translation currently there exist machine translation tools and memory translation tools. Using machine translation tools, a block of text or sentence is translated via word by word look-up of each sentence of text. Thus, each translated word is directly looked up in a dictionary database. The machine translation software then combines these translations into a meaningful sentence. Using translation memory tools, a block of text is translated directly sentence by sentence or segment by segment. That is, each sentence or segment is looked-up in a previously compiled database of linguistic phrases and sentences. This method is an improvement over machine translation based on the amount of these phrases found in the linguistic phrase database.

Various methods have been employed to allow the translation of documents via purely computerized means. For example, Carbonell et al., in U.S. Pat. No. 6,173,785, disclose an interactive text editor that enforces lexical and grammatical constraints on a natural language subset used by authors to create original text. These constraints help disambiguate the text to ensure translatability. Further, Motoyama, in U.S. Pat. No., 6,208,956, teaches encoding documents with Standard Generalized Markup Language (SGML) tags and using different translation resources depending on the tags. The tags may indicate types of documents or portions of the document being translated. By encoding the document this way, more accurate machine translation can be performed without imposing overly restrictive rules on the words and phrases included in the document to be translated.

Other methods of constraining and structuring grammar and vocabulary are also known. Different manners of handling semantic and idiomatic words and phrases, and methods of handling words with multiple meanings using statistical analysis are being developed and improved. Further, modem translation systems may include side-by-side views of original text and translated text to assist users. Additionally, these systems may allow users to select portions of the machine translation to be accepted and other portions to be rejected.

### SUMMARY OF INVENTION

In general, in one aspect, a translation management method comprises comparing text to terms in at least one glossary, indicating matches between the terms and the text, and selectively inserting a translation of matching terms into the text.

In general, in one aspect, a translation management tool comprises at least one glossary containing terms and a translation of the terms, means for comparing text to the terms, means for indicating matches between the terms and the text, and means for selectively inserting a translation of matching terms into the text

In general, in one aspect, a translation management tool comprises at least one glossary containing terms and a translation of the terms, software executable on a computer for comparing text to terms in the at least one glossary, indicating matches between the terms and the text, and selectively inserting a translation of matching terms into the text.

In general, in one aspect, a translation management system comprises a processor, a memory, a display, and software stored in the memory and executable on the processor. The software is for selectively comparing text to terms in at least one of a plurality of glossaries, indicating on the display matches between the terms and the text, selectively inserting a translation of matching terms into the text, assigning a priority value to one of the plurality of the glossaries, assigning a priority value to another of the plurality of glossaries, selectively indicating matching terms from the one of the plurality of glossaries and not indicating matching terms from the another of the plurality of glossaries based on the priority value, and selectively indicating longest matching terms from the another of the plurality of glossaries.

Other aspects and advantages of the invention will be apparent from the following description and the appended claims.

### BRIEF DESCRIPTION OF DRAWINGS

FIG. 1 shows a typical computer system on which one or more embodiments of the present invention may be implemented.

FIG. 2 shows an exemplary GUI visual output in accordance with one or more embodiments of the present invention.

FIG. 3 shows an enlarged view of a portion of the exemplary GUI visual output shown in FIG. 2.

FIG. 4 shows a lookup window in accordance with one or more embodiments of the present invention.

FIG. 5 shows an exemplary options window in accordance with one or more embodiments of the present invention.

FIG. 6 shows an active glossary set window in accordance with one or more embodiments of the present invention.

FIG. 7 is a flow diagram describing a process in accordance with one or more embodiments of the present invention.

FIG. 8 is a flow diagram describing an exemplary second match processing method in accordance with one or more embodiments of the present invention.

FIG. 9 shows an exemplary resulting document after comparison in accordance with one or more embodiments of the present invention.

FIG. 10 shows an exemplary translation window in accordance with one or more embodiments of the present invention.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to a method and apparatus for foreign language translation involving Universe translation tools. Universe translation tools relate to a translation assistance device. The Universe translation tools analyze sentences and provide additional definitional information based on words and phrases found. Based on the words and phrases found in a given sentence, those words and phrases are looked-up in a specific glossary to provide the additional definitional information. The glossaries contain source and target language definitional phrases and are specific to given identifiable topics. Glossaries are project and/or subject specific documents and are more narrowly tailored to one or more translations of a given word or phrase than a dictionary. Dictionaries are typically broad documents covering all possible definitions and respective translations for a word or phrase. Further, the Universe translation tools apply to any language pair, e.g., English to/from French, English to/from Spanish, English to/from Russian, etc.

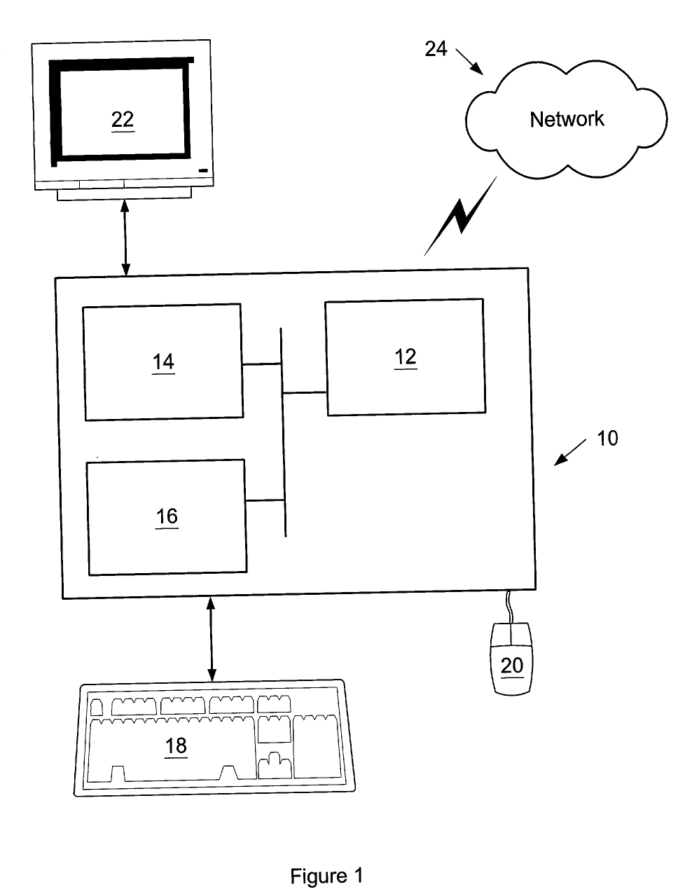

The invention may be implemented on virtually any type computer regardless of the platform being used. For example, as shown in FIG. 1, a typical computer (10) has a processor (12), associated memory (14), a storage device (16), and numerous other elements and functionalities typical to today's computers (not shown). The computer (10) has associated therewith input means such as a keyboard (18) and a mouse (20), although in an accessible environment these input means may take other forms. The computer (10) is also associated with an output device such as a display (22), which may also take a different form in an accessible environment. The computer (10) may be connected to a network or other resources (24).

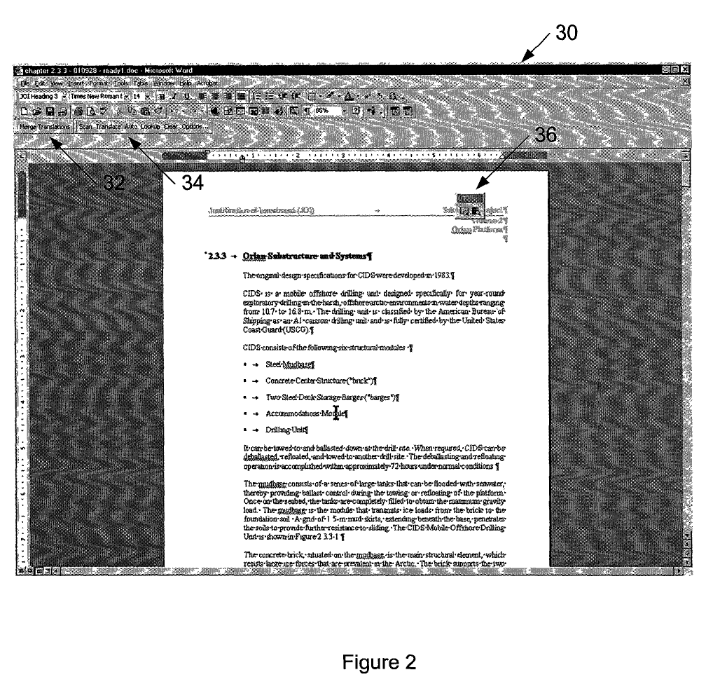

Referring to FIG. 2, the Universe translation tools are resident and selectable widgets existing in a Graphical User Interface (GUI), for example, buttons on the tool bar of Microsoft Word®. A GUI is part of a software application that interacts with a user via a graphical display. The GUI receives input from the user through different modes of access, such as a mouse and pointer combination, or through a keyboard. A visual output of a GUI is typically displayed on a display device, such as a computer monitor screen, and includes widgets that allow the user to interact with the GUI. Examples of widgets include windows, captions, buttons, labels, menu bars, toolbars, dialog boxes, menus, icons, etc. Widgets may also represent software applications that may be executed by the user or a pointer icon that represents the position of the mouse.

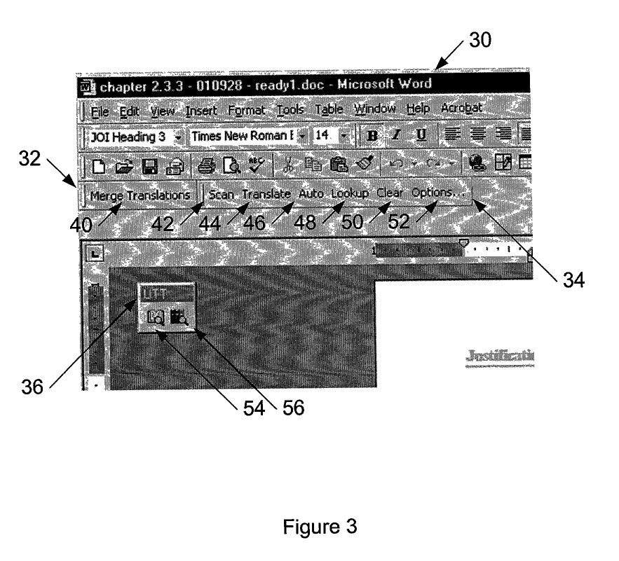

An exemplary GUI visual output is shown in FIGS. 2-3. As can be seen, a window (30) displays Microsoft Word® together with an open document. The Universe translation tool buttons are included in fixed tool bars, e.g., tool bars (32), (34) and floating tool bars, e.g., tool bar (36). These tool bars (32), (34), (36), represent various functions of the Universe translation tool software. Those skilled in the art will appreciate how to create and allow dynamically positioning of widgets such as these. Accordingly, detailed description of such processes is not included herein.

The various buttons of the tool bars (32), (34), (36) invoke different functions of the Universe translation tool software. Specifically, the fixed tool bar (32) contains a “Merge Translation” button (40), which causes the translations of known terms into the text of the document.

In the fixed tool bar (34), 6 buttons, i.e., a “scan” button (42), a “translate” button (44), an “auto” button (46), a “lookup” button (48), a “clear” button (50), and an “options . . . ” button (52). These buttons cause various functions to be invoked. The scan button (42) causes the active document to be scanned for known terms and the found terms to be identified. The translate button (44) causes the known terms in the active document to be translated. This translation process proceeds similarly to spell checking. Known terms are shown together with their translation and a user may choose to insert the translation or insert all translations. The auto button (46) searches the document for known terms and automatically inserts translations for all known terms found. The lookup button (48) causes a highlighted term to be searched for in the active glossaries or, if no text is highlighted, causes a lookup window to be displayed. The clear button (50) removes all notations regarding known terms from the active document. The options . . . button (52) causes the glossary options window to be displayed.

In the floating tool bar (36), icons representing the lookup command, i.e., icon button (54), and the view active glossary set command, i.e., icon button (56) are included. The icon button (54) causes a highlighted term to be searched for in the active glossaries or, if no text is highlighted, causes a lookup window to be displayed. This allows users to search for known terms in a specified glossary. The button (56) causes the active set of glossaries to be displayed. From this window, user can change which glossaries are active and the priority of the active glossaries. Those skilled in the art will appreciate that the labels and icons used as well as the positioning and organization of the buttons described above are merely exemplary and may be modified in numerous ways without departing from the scope of the invention.

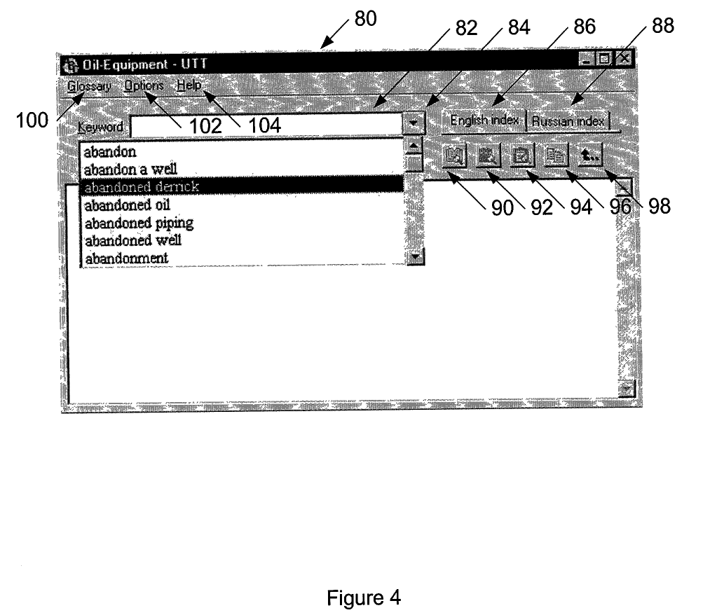

FIG. 4 shows a lookup window in accordance with one or more embodiments of the present invention. The lookup window (80) is displayed when the lookup button (48) or icon button (54) is selected. The lookup windows (80) includes a text box (82) for the entry of a keyword to be looked up together with a pull down menu (84) of terms found in the glossary. Users can select between language indexes with tabs (86), (88). In the example, shown English index and Russian index tabs are included.

Control buttons (90), (92), (94), (96), (98) allow a selected term to be looked up, the active glossary set to be viewed and modified, the clipboard to be viewed and modified, a copy function to be performed, and a back function to be performed respectively. Menu items are also included in the lookup window, which allow various functions to be performed. The “glossary” menu item (100) causes the active glossary set window to be displayed. From the active glossary set window, a user can select a glossary and add, remove, and prioritize glossaries in the active set. The “options” menu item (102) causes the glossary options window to be displayed. From the glossary options window, a user may modify how the Universe translation tools search documents, the source language of the document to be searched, and how found terms are identified in the document. Lastly, the “help” menu item (104) causes a help window to be displayed. The help window contains program documentation.

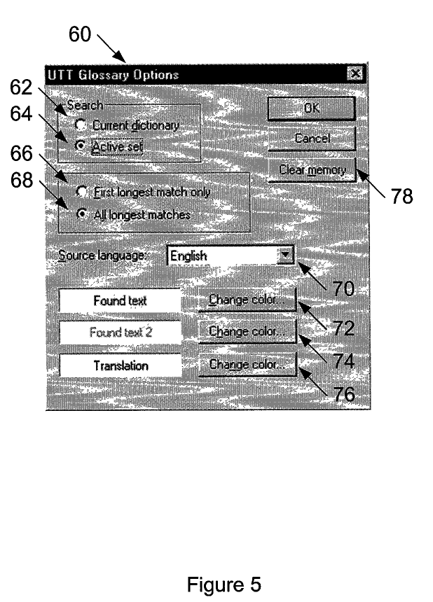

Referring to FIG. 5, the glossary options window (60) is shown. The glossary options window (60) is displayed when the options button (52) is selected. From the glossary options window (60), a user may modify how the Universe translation tools search documents, the source language of the document to be searched, and how found terms are identified in the document.

As an example, radio buttons (62), (64) are used to allow a user to select between searching for terms only in the current glossary or in the active set respectively. Radio buttons (66), (68) are used to allow a user to select between identifying only the first longest match or all longest matches respectively. A pull down menu (70) is used to allow the source language of the document to be selected. Finally, change color buttons (72), (74), (76) allow a user to select which colors indicate found terms and identify translation text respectively. Also, clear memory button (78) removes all notations regarding known terms and translations from the active document like clear button (50). Lastly, ok and cancel buttons are included and operate similarly to other standard windows.

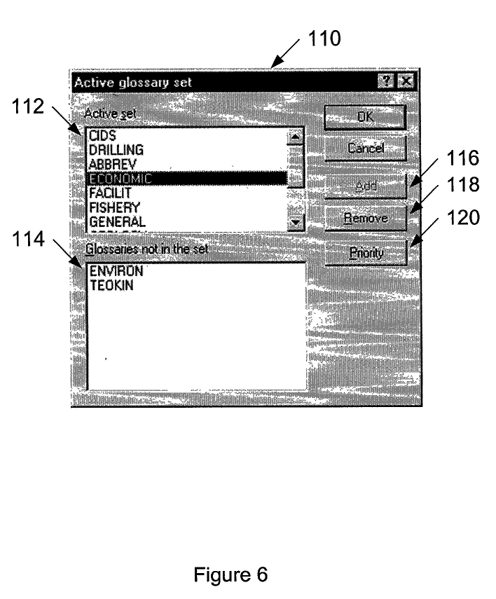

FIG. 6 shows an active glossary set window in accordance with one or more embodiments of the present invention. The active glossary set (110) is displayed when the icon button (56) or the glossary menu item (100) in the lookup window (80) is selected. From the active glossary set window, a user can select a glossary and add, remove, and prioritize glossaries in the active set. All available glossaries are listed in either, the active set box (112) or the glossaries not in the active set box (114). Glossaries can be added or removed from the active set using buttons (116) and (118) respectively after selecting the glossary from the appropriate box.

A “top-down” priority is associated with the glossaries listed in the active set. To change the priority of a glossary, the priority button (120) is used after selecting the glossary. In the example shown, a single priority button is included and acts as a “bubble-up” in priority, i.e., the selected glossary moves up to the next higher priority each time the priority button is pressed. Those skilled in the art will appreciate many variations of this function are available that do not depart from the scope of the invention. Lastly, ok and cancel buttons are included and operate similarly to other standard windows.

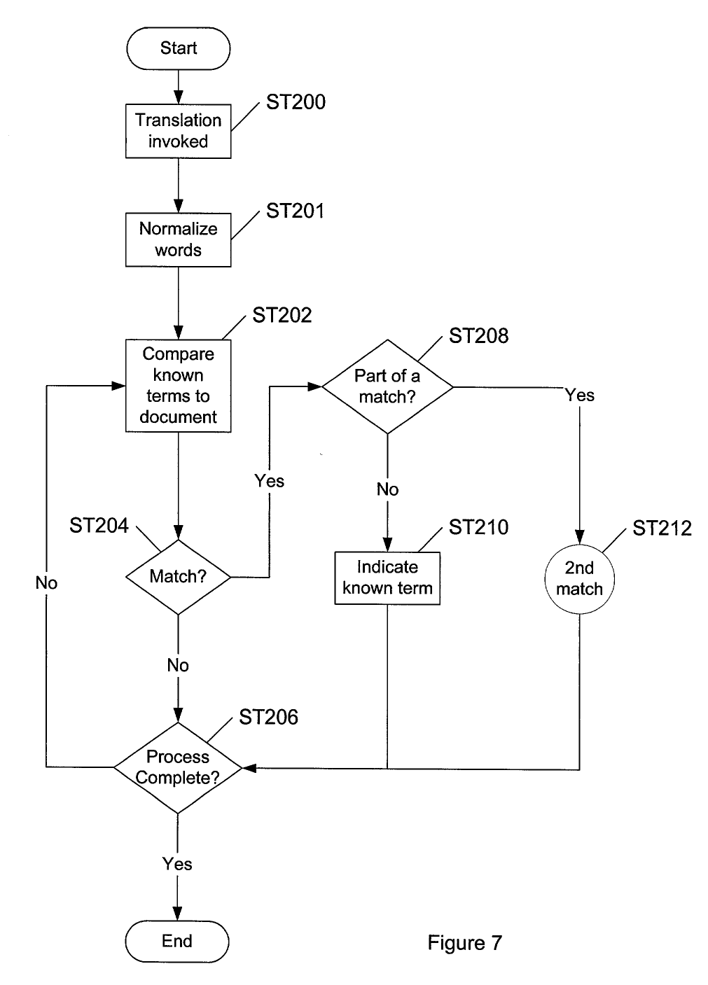

FIG. 7 is a flow diagram describing a process in accordance with one or more embodiments of the present invention. When a user selects one of the translation invoking buttons described above (step 200), the open document is parsed for known terms (step 202). Prior to parsing, the selected terms are normalized (step 201). Normalization is a process which is used to bring words to their root component for comparison to those words appearing in a given glossary. For the English language, normalization involves finding plural nouns and past tense verbs and converting them to singular and present tense respectively. Those skilled in the art will appreciate that in other languages normalization may involve a more complex determination of the root component of a particular word.

The parsing of the document may involve comparing the terms included in the active glossary or active set of glossaries to the text of the document to find matches. As the comparison progresses, when there is no match for a known term in the text of the document (step 204), the system determines whether all known terms have been compared and the process is now complete (step 206). If so, the process ends. Otherwise, the system continues comparing known terms to the text of the document (step 202).

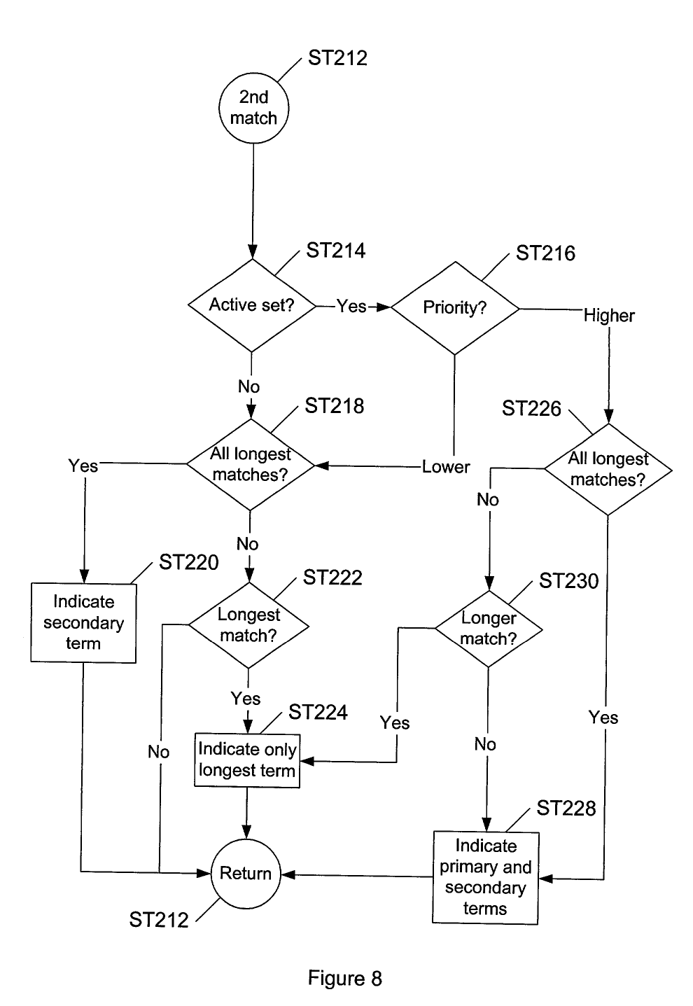

When a match for a known term is found (step 204), the system determines whether the known term found is part of another known term (step 208). If not, the known term is indicated as such (step 210) and the system determines whether the process is now complete (step 206). If the known term is part of another term (step 208), then one of several determinations may be made depending on the options selected by the user and the embodiment of the present invention being employed. An exemplary second match processing method (step 212) is described below in FIG. 8. After returning from the second match processing (step 212), the system determines whether the process is now complete (step 206).

Referring to FIG. 8, first the system determines whether an active set is selected or a single glossary is being used (step 214). If there is an active set (step 214), the system determines whether the priority of the found second match is higher or lower than the existing match that it is a part of (step 216). If the priority of the second match is lower than that of the existing match (step 216), then the system checks whether all longest matches are to be returned (step 218). As discussed above, whether all longest matches or only the single longest match is returned is a user-selectable option.

If all longest matches are to be returned (step 218), then the second match is returned as a secondary found term (step 220) and the process returns (step 212). On the other hand, if only the single longest match is to be returned (step 218), then the system compares the second match to the existing match to determine whether the second match is the longest match (step 222). If not, the process returns (step 212). If so, the second match is indicated as the longest match and the existing match is no longer indicated (step 224). Then, the process returns (step 212).

If the priority of the second match is higher than the existing match (step 216), then the system still determines whether all longest matches are to be returned (step 226). If so, the second match is indicated as a primary match and the existing match is indicated as a secondary match to reflect priority (step 228). Then, the process returns (step 212). Otherwise, the system determines whether the second match is longer than the existing match (step 230). If so, the second match is indicated as the longest match and the existing match is no longer indicated (step 224) as above. However, if the second match is not the longest match (step 230), both the second match and the existing match are returned because the existing match is the longest match and the second match is a higher priority match (step 228). Then, the process returns (step 212).

Those skilled in the art will appreciate that the number of steps described above may be greater or fewer in number, or the steps may occur in a different sequence than shown above given the particular embodiment of the present invention being employed without departing from the scope of the invention.

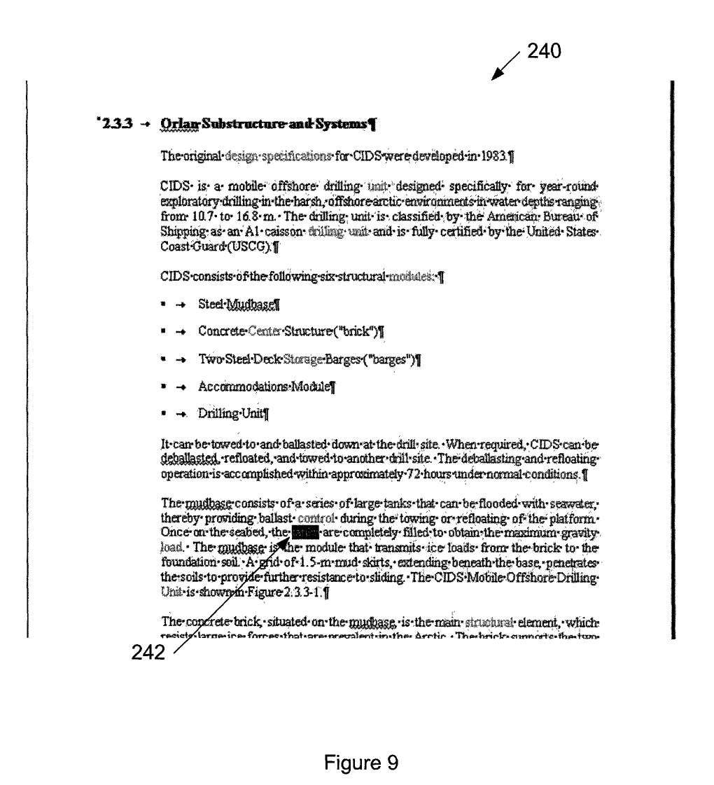

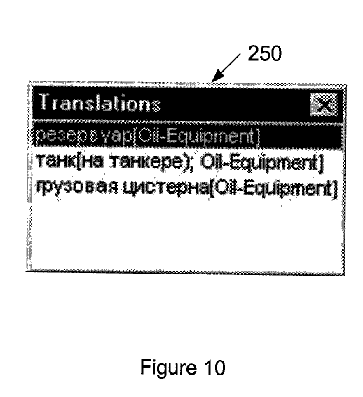

Referring to FIGS. 9-10, an exemplary document resulting from the comparison described above is shown. The document (240) is entirely the same text as the original document, however, as can be seen, indications exist throughout to show which terms are known terms. Further, different colors are used to show primary and secondary known terms. From these indications, expert translators will be able to quickly ascertain which terms are specific technical terms and which terms are common (at least to the selected glossary). After looking at the document having indications of known terms, a user can highlight a word or phrase indicated as known, e.g., the word “tanks” (252), and use the lookup button (48) or icon button (54) to see the matching translation (250).

Advantages of one or more embodiments of the present invention may include one or more of the following. In one or more embodiments, the present invention facilitates the translation of words, sentences, and phrases by noting terms appearing in a document that correspond to technical or otherwise significant words, sentences, and phrases stored in glossaries. Which glossaries to be searched and the priority of matches found can be specified. By having selectable glossaries of terms, translations performed by different expert translators will be uniform. Technical terms that having a given meaning in the technical context and a separate meaning in regular usage will be properly translated. Easily translatable terms can be suggested or completely left to expert translators.

Automatic translation of the most difficult project-specific terminology can be performed. Automatic and full utilization of the glossary database during the translation process is possible. Absolute compliance with project approved terminology and full compliance of the translated materials with the approved Glossaries can be efficiently effected. Faster, more consistent and accurate translation can be obtained. Documents of pre-processed material for distribution to freelancer translators are provided. Ease of updates and traceability, and ease of database management is increased. Those skilled in the art appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A translation management method comprising:
comparing text to terms in at least one glossary;
indicating matches between the terms and the text; and
selectively inserting a translation of matching terms into the text.

2. The translation management method of claim 1, further comprising:
normalizing the text before comparing the text to the terms.

3. The translation management method of claim 1, further comprising:
selectively indicating only longest matching terms.

4. The translation management method of claim 1, further comprising:
selectively indicating multiple matching terms and the text.

5. The translation management method of claim 1, further comprising:
comparing the text to terms in a plurality of glossaries.

6. The translation management method of claim 5, further comprising:
selectively comparing the text to at least one of the plurality of glossaries.

7. The translation management method of claim 5, further comprising:
assigning a priority value to one of the plurality of the glossaries;
assigning a priority value to another of the plurality of glossaries; and
selectively indicating matching terms from the one of the plurality of glossaries and not indicating matching terms from the another of the plurality of glossaries based on the priority value.

8. The translation management method of claim 7, further comprising:
selectively indicating longest matching terms from the another of the plurality of glossaries.

9. A translation management tool comprising:
at least one glossary containing terms and a translation of the terms;
means for comparing text to the terms;
means for indicating matches between the terms and the text; and
means for selectively inserting a translation of matching terms into the text.

10. The translation management tool of claim 9, further comprising:
means for normalizing the text before comparing the text to the terms.

11. The translation management tool of claim 9, further comprising:
means for selectively indicating only longest matching terms.

12. The translation management tool of claim 9, further comprising:
means for selectively indicating multiple matching terms and the text.

13. The translation management tool of claim 9, further comprising:
means for comparing the text to terms in a plurality of glossaries.

14. The translation management tool of claim 13, further comprising:
means for selectively comparing the text to at least one of the plurality of glossaries.

15. The translation management tool of claim 13, further comprising:
means for assigning a priority value to one of the plurality of the glossaries;
means for assigning a priority value to another of the plurality of glossaries; and
means for selectively indicating matching terms from the one of the plurality of glossaries and not indicating matching terms from the another of the plurality of glossaries based on the priority value.

16. The translation management tool of claim 15, further comprising:
means for selectively indicating longest matching terms from the another of the plurality of glossaries.

17. A translation management tool comprising:
at least one glossary containing terms and a translation of the terms;
software executable on a computer for
comparing text to terms in the at least one glossary;
indicating matches between the terms and the text; and
selectively inserting a translation of matching terms into the text.

18. The translation management tool of claim 17, wherein the software is further for normalizing the text before comparing the text to the terms.

19. The translation management tool of claim 17, wherein the software is further for selectively indicating only longest matching terms.

20. The translation management tool of claim 17, wherein the software is further for selectively indicating multiple matching terms and the text.

21. The translation management tool of claim 17, wherein the software is further for comparing the text to terms in a plurality of glossaries.

22. The translation management tool of claim 21, wherein the software is further for selectively comparing the text to at least one of the plurality of glossaries.

23. The translation management tool of claim 21, wherein the software is further for assigning a priority value to one of the plurality of the glossaries;
assigning a priority value to another of the plurality of glossaries; and
selectively indicating matching terms from the one of the plurality of glossaries and not indicating matching terms from the another of the plurality of glossaries based on the priority value.

24. The translation management tool of claim 23, wherein the software is further for selectively indicating longest matching terms from the another of the plurality of glossaries.

25. A translation management system comprising:
a processor;
a memory;
a display; and
software stored in the memory and executable on the processor for selectively comparing text to terms in at least one of a plurality of glossaries;
indicating on the display matches between the terms and the text;
selectively inserting a translation of matching terms into the text;
assigning a priority value to one of the plurality of the glossaries;
assigning a priority value to another of the plurality of glossaries;
selectively indicating matching terms from the one of the plurality of glossaries and not indicating matching terms from the another of the plurality of glossaries based on the priority value; and
selectively indicating longest matching terms from the another of the plurality of glossaries.
